(19) United States
(12) Patent Application Publication
(10) Pub. No.: US 2009/0280795 A1
(43) Pub. Date: Nov. 12, 2009

(54) System and Method for the Management of the Mobile Device Life Cycle

(76) Inventor: John O'Shaughnessy, Brunton-Wiltshire (GB)

Correspondence Address: ST. ONGE STEWARD JOHNSTON & REENS, LLC, 986 BEDFORD STREET, STAMFORD, CT, 06905-5619, US

(21) Appl. No.: 12/437,811

(22) Filed: May 8, 2009

Related U.S. Application Data
(60) Provisional application No. 61/051,513, filed on May 8, 2008.
(60) Provisional application No. 61/051,534, filed on May 8, 2008.
(60) Provisional application No. 61/051,538, filed on May 8, 2008.
(60) Provisional application No. 61/051,543, filed on May 8, 2008.
(60) Provisional application No. 61/051,549, filed on May 8, 2008.

(51) Int. Cl. H04M 3/00

(52) U.S. Cl. 455/419

(57) ABSTRACT

A system for the management of mobile devices, including a system server having at least one database, wherein the database includes data objects indicative of a plurality of groups of mobile device users, a plurality of applications, and a plurality of IT policies, wherein the data objects are independent of a mobile device type, an interface module on the system server for generating instructions to communicate to each of two or more device-specific mobile device management servers, wherein each of the device-specific mobile device management servers are in communication with a plurality of mobile devices, and software executing on the system server for deploying at least one of an application and an IT policy to one or more of the plurality of mobile devices by transmitting the instructions to at least one of the plurality of device-specific mobile device management servers.

### CROSS-REFERENCE TO RELATED APPLICATIONS

The present application claims the benefit under 35 U.S.C. §119(e) of the U.S. Provisional Patent Application Ser. Nos. 61/051,513, 61/051,534, 61/051,538, 61/051,543, and 61/051,549, each filed on May 8, 2008, the contents of which are incorporated herein by reference.

### FIELD OF THE INVENTION

The invention relates generally to mobile electronic devices, such as smartphones, and in particular to the management of the mobile device life-cycle within organizations.

### BACKGROUND OF THE INVENTION

Mobile electronic devices, such as the Blackberry® developed by Research in Motion Limited (RIM) and others including Symbian devices, Windows Mobile devices, iPhone and Palm devices, have become common place in many industries and professions. Organizations generally invest in mobile devices and the associated infrastructure to increase the accessibility and effectiveness of their employees.

Before the advent of powerful handheld computing devices such as Blackberry, Windows Mobile and iPhone, investment in tools and processes was carrier-centric and focused on things such as device supply logistics, voice plan management, billing and integration with asset management systems.

The availability of more powerful mobile data devices has meant that customers are investing in tools and processes to directly integrate those devices into their infrastructure through ‘behind the firewall’ technology such as the Blackberry Enterprise Server, Microsoft MDM and, more recently, Apple's iPhone device configuration utility. These tools however only provide basic connectivity and narrow management capability so organizations are looking for solutions that more effectively integrate mobile devices into the way they do business. For instance; reducing the cost of, and speeding up, mobile application deployment can save very large amounts of money and, more importantly, make the business process more effective with a resultant positive effect on the bottom line.

When an organization deploys mobile devices to its employees with the intention of those devices providing access to corporate data (email, CRM, Intranet, LOB, etc.) then in all cases a secure infrastructure to provide end-to-end communications between the source of the data and the device will have to be implemented.

For Blackberry devices, the device manufacturer, RIM (Research in Motion), in collaboration with the wireless carriers provides a proprietary infrastructure consisting of network components on both sides of the corporate firewall. This infrastructure provides secure communications and, through the Blackberry Enterprise Server, tight levels of control over mobile IT policies and other device and user mobile parameters.

For Windows Mobile devices, Microsoft have developed a device communications and management infrastructure that is fundamentally different to that of RIM although there are network components that provide conceptually similar roles such as ActiveSync mobile IT policy management through the Exchange Server.

Whatever mobile device solution is chosen by an organization, it will come with a management capability ‘out of the box’ that has varying degrees of functionality and sophistication. These proprietary mobile management solutions are designed to offer device management capabilities and communicate directly with mobile devices in order to controls and report on usage.

However, device manufacturers and vendors are interested in delivering mobile device management solutions that are specific to their own devices and that support their own product range. This means that an organisation wishing to deploy mobile devices from more than one manufacturer is faced with the problem of implementing and managing multiple management solutions.

Furthermore, each proprietary device management product is device-focused and establishes direct communications only with their devices in order to tightly control what the user is allowed to do.

What is desired, therefore, is a system and methods for helping organizations maximize the business benefit that mobile devices can bring and reduce cost throughout the mobile device life-cycle.

### SUMMARY OF THE INVENTION

This invention takes the view that a holistic view of the mobile device life cycle is a better model for identifying and delivering solutions. This approach does away with barriers between internal business processes, stakeholders and device-specific technologies.

Accordingly, it is an object of the present invention to provide a system or tool that sits ‘on top of’ one or more proprietary device management solutions installed on an organizations IT infrastructure and provide a level of abstraction that eliminates vendor-specific attributes to enable all devices to be managed in the same way and in the same console.

It is a further object to provide a system that integrates with an organization's business processes to enable automation of admin actions when events that would affect a user's mobile experience occur, such as changing roles or joining a team or group with specific requirements for access to data and applications.

The invention described here is fundamentally different to solutions for the direct management of mobile devices. Direct management solutions contain various methods for direct communications between a management server and the devices being managed; examples of this include the Blackberry Enterprise Server (“BES”) and certain components of Microsoft Exchange, that each establish a direct communications link with each device under management. By contrast, this invention communicates only with the proprietary mobile management servers and not directly with the devices themselves. Instead the invention uses the proprietary mobile management servers as a proxy to implement manufacturer and infrastructure-specific actions on devices. The invention operates independent of the link between the device and the device-specific management server (e.g., routers, firewalls, data-centers) and method of communication between the device and the device-specific management server. The invention trusts and empowers the device-specific management server to execute the commands requested of it.

In one embodiment, a system for the management of mobile devices is provided including a system server having at least one database, wherein the database includes data objects indicative of a plurality of groups of mobile device users, a plurality of applications, and a plurality of IT policies, wherein the data objects are independent of a mobile device type. The system includes an interface module on the system server for generating instructions to communicate to each of two or more device-specific mobile device management servers, wherein each of the device-specific mobile device management servers are in communication with a plurality of mobile devices, and software executing on the system server for deploying at least one of an application and an IT policy to one or more of the plurality of mobile devices by transmitting the instructions to at least one of the plurality of device-specific mobile device management servers.

The invention thus provides a layer of abstraction on top of one or more proprietary mobile device management solutions (such as the Blackberry Enterprise Server) in order to provide a unified set of functionality for the management of Mobile devices.

Other objects, features and advantages according to the present invention will become apparent from the following detailed description of certain advantageous embodiments.

### BRIEF DESCRIPTION OF THE DRAWINGS

FIG. 1 illustrates a mobile device management system according to an exemplary embodiment of the present invention.

FIG. 2 illustrates a system server of the system shown in FIG. 1.

FIG. 3 illustrates a mobile device management system according to an exemplary embodiment of the present invention.

FIG. 4 illustrates a mobile device management system according to an exemplary embodiment of the present invention.

### DETAILED DESCRIPTION OF THE INVENTION

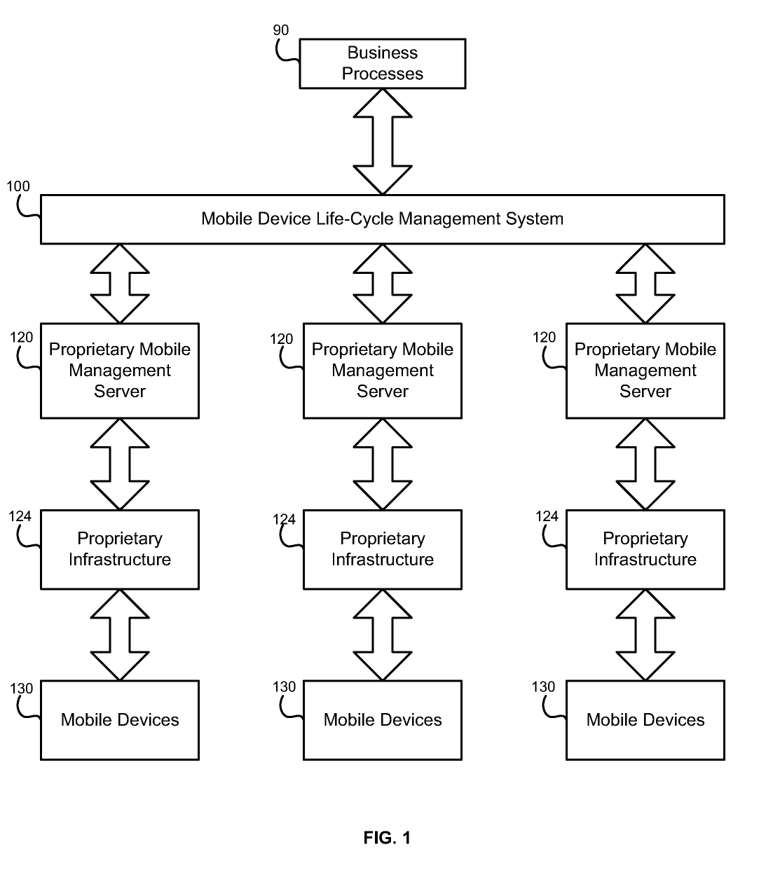

FIG. 1 illustrates an exemplary embodiment of the mobile device management system according to present invention. The mobile device management system includes a Mobile Device Life Cycle Management System 100. The system 100 may comprise a system server and/or computer, and any number of software modules executing on the system server or computer for implementing the functionality of the system 100 described herein. The system 100 is in communication with one or more business processes or systems 90, e.g., an organization server and/or database. The system 100 is also in communication any number of proprietary or device-specific mobile device management servers 120. The system 100 provides a layer of abstraction on top of the device-specific mobile device management servers 120 in order to provide a unified set of functionality for the management of mobile devices 130.

The system 100 provides applications, IT policies and other data for management of the mobile devices 130. Different device types, operating system (“OS”) versions and mobile infrastructures may require different versions of an application and some applications will only work on some devices (for instance Windows Mobile or Blackberry). Organizations deploying a wide variety of devices from different manufacturers and Mobile infrastructures require a scalable mechanism for managing this and handling applications designed for certain devices, operating systems and Mobile Infrastructures. Each proprietary or device-specific management server 120 has a proprietary or device-specific infrastructure 124 by which it communicates information and data with its devices 130.

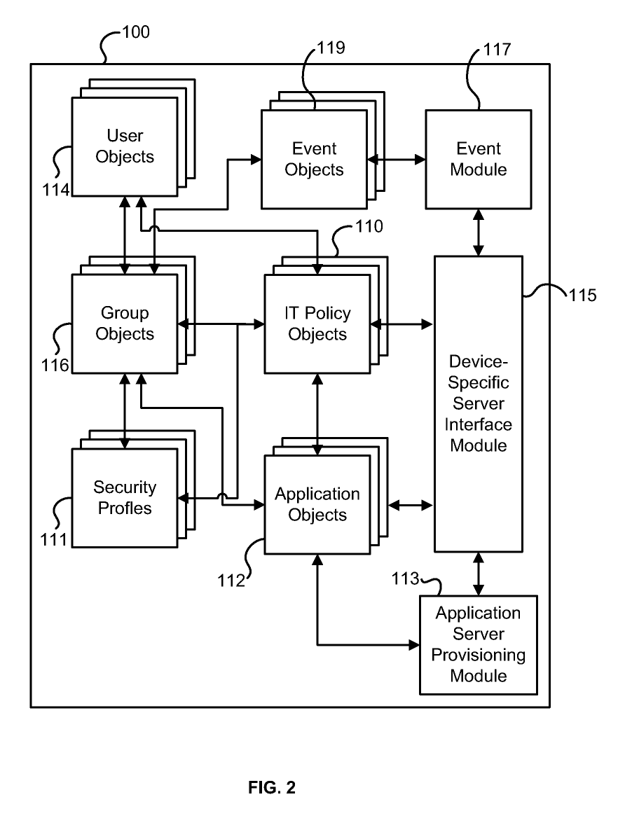

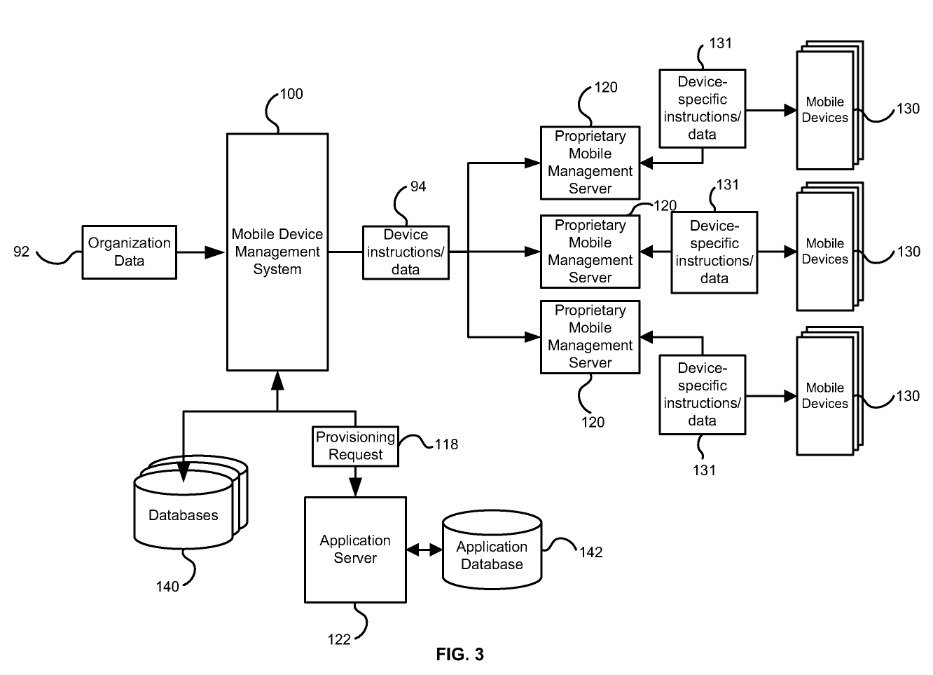

FIG. 2 illustrates an exemplary embodiment of the system or server 100. In order to provide applications to the mobile devices 130, a system administrator registers an application with the system 100. Once registered, the application can be managed and deployed. The act of registration generates an internal representation or object (to the system 100) of the application 112 that conforms to a standard definition. This internal representation of the application 112 (e.g., abstracted application or application object) is identical in structure to all other registered applications regardless of device, operating system, mobile infrastructure or other factors, all that will differ are application-specific content and attributes. The abstracted application 112 retains references to the external location of the application, which may be stored on an application database 142 in communication with the system 100 (see, e.g., FIG. 3), and these references may well be application, vendor, device, operating system or Mobile Infrastructure-specific.

Once an internal, abstracted application entity 112 is created, it can then be treated identically to all other registered applications 112 and have relationships defined between it and users 114, groups 116, IT policies 110 and other applications 112. As described in more detail below, IT policies 110 and other data may be similarly represented as objections or abstracted features executing on the system 100 and/or databases 140 thereof. The data objects shown in FIG. 2 may be stored on the system 100, the databases 140, or a combination of both.

Some applications 112 require that certain IT policy settings 110 are set to a certain value. For example, an application 112 that uses a particular function of the mobile device, such as Bluetooth, to print documents directly to a printer will require that the Bluetooth function is enabled on the device. The system 100 contains functionality to allow a system administrator to select one or more IT policy settings 110 and associated those new settings with an application 112. When an application 112 is deployed to a device 130, the system 100 will update the IT policy 110 in force on the device 130 with the new settings.

The system 100 may have previously determined the appropriate IT policy for the device 130 which may be in force before the application 112 is deployed. Once the application 112 is deployed to the device 130, the system 100 ensures that the subset of IT policy settings required by the application 112 is set to the required values. This means that the values for the application-specific IT policy settings (and only those settings) override those of the IT policy previously on the device 130.

Some applications 112 use custom IT policy settings 110 to set application-specific information such as application server IP address or a username. These custom IT policy settings 110 are not native to the device 130 or Mobile infrastructure and so have to be created manually by the system administrator. The system 100 contains functionality to allow the system administrator to create new custom IT policies 110, store these in the system and associate them with a specific application 112. Once an application 112 is deployed to a device 130 the Mobile Device Life Cycle Management System 100 will ensure that any custom IT policy settings 110 are automatically deployed to the device 130 alongside any application-specific standard IT policy settings 110.

The system 100 may have a setting to allow the system administrator to determine whether application-specific IT policy 110 settings 110 and custom IT policy 110 settings are able to override the IT policy 110 in force on a device when an application 112 is deployed.

In many cases, an application user will need to be provisioned on an application server 122 in order to use the service. This is generally done in a number of ways and can involve the manual creation of accounts on the application server 122. The Mobile Device Life Cycle Management System 100 contains functionality to enable automatic applications server provisioning.

As shown in FIG. 2, the system includes application server provisioning functionality or software module 113 which can be enabled on a system-wide or per-application basis so that the organization can have a mixture of manually provisioned servers, servers provisioned through some proprietary means and servers provisioned using the Mobile Device Life Cycle Management System's 100 application server provisioning module 113. The application server provisioning module 113 can be set so that the user is automatically provisioned on the application server 122 following any of events listed here:
As soon as the Mobile Device Life Cycle Management System 100 determines that the user should have a certain application through group membership;
As soon as possible after the application 112 is deployed to the device;
At a pre-determined time or to a pre-determined schedule (in the case of multiple application recipients) and after the application 112 has been deployed to the device 130;
Through being (or becoming) a member of a group, regardless of whether the application has been deployed to the device or whether the user's group membership dictates use of the application in question.

When a provisioning event occurs, the Mobile Device Life Cycle Management System 100 generates a provisioning request 118; this request contains a set of data related to the user 114 which can include information about the device 130. The provisioning request 118 is received by the application server 122 which then used proprietary logic to perform the provisioning action.

The provisioning events can be specified on a system-wide or application-specific basis so that, for instance, one application server 122 receives provisioning requests 118 when an application 112 is deployed to a device 130 and another only received provisioning requests at a particular time every day for devices 130 that have received the application 112 since the last provisioning time.

To make it easier for application vendors to integrate their provisioning systems with the Mobile Device Life Cycle Management System 100, there may be one or more standard methods made available to vendors to enable them to conform to provisioning requests 118 generated by the Mobile Device Life Cycle Management System 100. One of these standards will be a web service definition that can be implemented on the application server 122 (or hosted by another server on behalf of it).

In the case of the Web Services example, the Mobile Device Life Cycle Management System 100 will send a provisioning request 118 to the application server's 122 Web Service, supplying a range of user and device information. The web service may or may not then send a confirmation back to the Mobile Device Life Cycle Management System 100. On the application server 122 side of the Web Service is a vendor-specific logic to perform the provisioning request 118 using the information provided by the Mobile Device Life Cycle Management System 100. Each provisioning request 118 made by the Mobile Device Life Cycle Management System 100 can be for one or more users 114, allowing the batching of provisioning events.

In some embodiments, the Mobile Device Life Cycle Management System 100 may also have the functionality to send provisioning requests 118 to the proprietary or device-specific management servers 120, which communicate with the mobile devices 130. The provisioning request 118 is used when a new user is being provisioned on a device or if an existing user is updating his old device 130.

Upgrading mobile applications 112 requires that all or some of a population of mobile devices 130 have one version of an application 112 replaced with a different one. The Mobile Device Life Cycle Management System 100 may contain functionality to allow multiple versions of an application 112 to be simultaneously registered. In some instances, the versions do not necessarily have to be related applications 112 or even from the same vendor. The system administrator defines what application 112 represents an upgrade of another and it may be the case that an application 112 from one vendor is to be ‘upgraded’ to a different application 112 from another vendor.

Once the system administrator has registered an upgraded version of an application 112, they must then specify how the upgrade should take place using a combination of one or more upgrade options, the options include but are not limited to:
Upgrade as fast as the system and infrastructure permits;
Target a sub-group or groups first (as defined by an application group) and only complete the upgrade once the system administrator has confirmed that the sub-groups have been successfully upgraded;
At a specified rate (for instance 100 users per day);
At specified times (for instance 03:00 or only at weekends);
Enable/disable a subset or all of the device and user pre-requisites for application deployment (for instance; not when roaming or on ‘home’ network;
Time/date to start the upgrade;
Time/date to stop the upgrade.

Some proprietary or device-specific mobile management servers 120 have constraints that functionally and practically limit the rates at which applications 112 can be deployed/upgraded and/or data rates. The Mobile Device Life Cycle Management System 100 may contain knowledge of these constraints and have settings that allow the system administrator to determine how to deal with them. For instance, in the case of a Blackberry Enterprise Server, there may be the option to specify system-wide and BES-wide the maximum rate of application deployment.

Because the Mobile Device Life Cycle Management System 100 is able to have multiple versions of an application 112 registered simultaneously, the system 100 makes no assumptions as to whether one version represents an upgrade of another. An application may simply be for a different OS/firmware version or for a different device model. For this reason, the system administrator can choose to manually indicate which of the several registered versions of an application 112 an upgrade of another version is. Even if a version of application 112 is registered that does represent an upgrade in real terms, in the context of the Mobile Device Life Cycle Management System 100, it is not an upgrade until the system administrators defines it to be so. When the system administrator defines one application 112 to be an upgrade of another, no automatic upgrade process will ensue. The existence of an ‘upgrade’ relationship alone is not enough; the system administrator must initiate the upgrade process, specifying the upgrade options that are to apply.

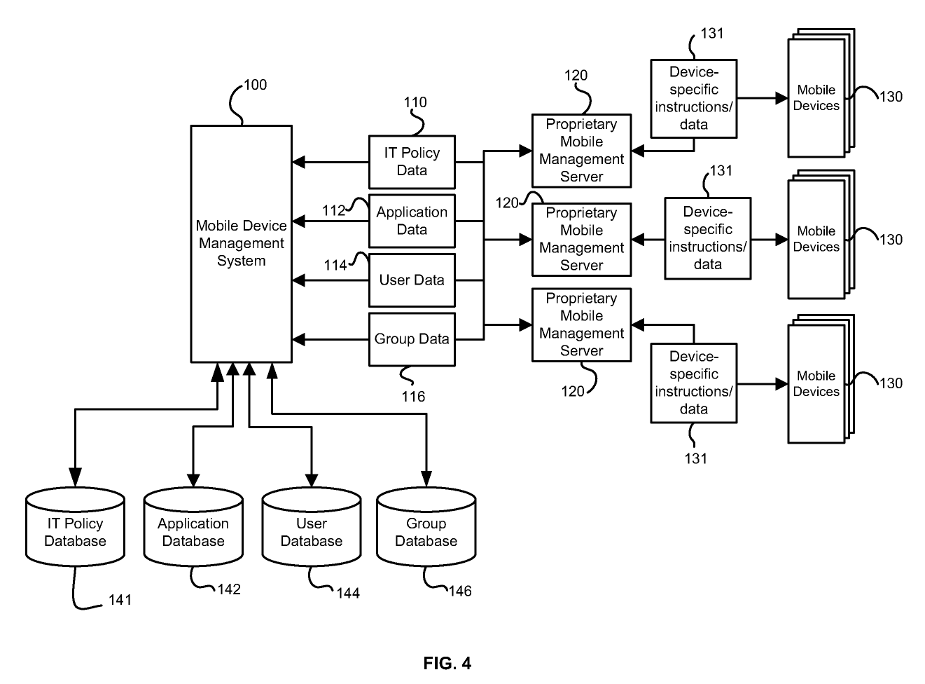

FIGS. 3 and 4 illustrate exemplary embodiments of the device management system according to the present invention. The system 100 sends (e.g., via a communication module or other software on the system server) device instructions/data 94, such as IT policies 110, application data 112, user data 114, and/or group data 116, to the proprietary or device-specific servers 120. The system 100 may send individual instructions to each server 120, including server-specific instructions/data, or a common set of instructions/data to all of the servers 120. The servers 120 receive and interpret the instructions/data 94, and communicate with their respective mobile devices 130 to implement the instructions/data 94 by providing device-specific instructions/data 131.

A user 114 role is defined within the system 100 by membership in, or association with, one or more groups 116. A group 116 represents a community of individuals, or groups that contain groups that eventually contain individuals. Some members of a group 116 may be mobile device 130 users. In some instances, a group 116 may have no mobile device users. Group data may be stored in the databases 140 in communication with the system 100, such as a group database 146.

The system 100 may deploy applications 112 and/or IT policies 110 to users and/or mobile devices 130 of particular based upon the user's group membership. If a user 114 is a member of a group 116, then they will receive applications 112 and/or IT policies that the system administrator has associated with that group 116.

As shown in FIG. 2, the system 100 sees a group 116 as a generic object; it is not concerned with how the group 116 is defined. The group may be created using any number of manual or automatic means. Examples of how groups 116 could be created include, but are not limited to:
1. Use of Directory Services such as LDAP, Microsoft Active Directory, etc.;
2. Database query;
3. XML file;
4. Manually typed list;
5. Proprietary systems such as ERP;
6. A query or join across two or more other groups.

A group 116 can also be defined by associated user data 114 accessible by the system 100 (e.g., from the business processes 90 and/or organization server or databases). The system 100 can use such user data as: job title, security clearance, work location, etc to determine what group or groups is associated with. User data may be stored on the system server 100, or the databases 140, such as a user database 144 or any database accessible by the system 100.

The system 100 is able to treat all group objects 116 identically regardless of how the group 116 was created and membership is maintained. User roles are defined by what group 116 a user is a member of. A user can have multiple roles within an organization and this is reflected by multiple group 116 membership.

As shown in FIG. 2, the system administrator is able to associate one or more applications 112 and/or IT policies 110 with a group 116. Once assigned, they are then deployed to those devices 130 using a range of methods. The deployment method (for instance an over-the-air (“OTA”) method, an email link, a website download) is specified by the system administrator on an application 112 and group 116 basis.

For each application 112 and group 116 combination, the system administrator is able to specify the application 112 disposition (optional, mandatory, etc.) and the deployment method. The combinations of disposition and deployment methods include, but are not limited, to the table below.

| Disposition | Explanation | Deployment method |
|---|---|---|
| Mandatory | This application must be deployed | OTA |
| | by the device and cannot be | |
| | removed by the user | |
| Optional | The application can be loaded to | OTA |
| | the device and removed by the | Email with download |
| | user | link |
| User Push | Optional, but the user must specify | OTA |
| | an OTA push of the app or that the | Email with download |
| | system send the user an email with | link |
| | an embedded download link | |
| User Pull | Optional, but the user must | Download from |
| | download the application from a | website |
| | server directly using the device, | |
| | possibly by directing the web | |
| | browser on the device to a | |
| | download server | |
| Not | Allow membership of other groups | Depends on what is |
| Specified | (i.e. other than the one currently | specified for the other |
| | being configured/viewed) | group(s) |
| | determine whether the device can | |
| | have the application and how it can | |
| | be deployed. | |
| Denied | The application is not allowed on | None |
| | the device | |

Additionally, the system administrator can specify that users receive an alert in the form of an email, SMS or other means such as an Instant messaging system. Telling them about the deployment, providing help and instructions.

The system 100 can have multiple groups 116 available for application 112 deployment purposes and these groups 116 can have constantly changing membership. The system 100 continuously monitors all groups 116 in which it has an interest in order to identify changes in membership and automatically deploy or remove applications 112 accordingly.

Users will often be members of more than one group 116 and each of these groups 116 may have different applications 112 associated with them, each with different dispositions and deployment methods. In order to determine what to do when a user 114 is a member of more than one group 116 and to manage conflicts with application 112 assignments, the system 100 contains functionality to allow the system administrator to define group dominance hierarchy. The dominance hierarchy is a ranking of all groups 116 that are to be used for application 112 assignment and deployment purposes.

When a user is a member of more than one group 116, the system 100 consults the group dominance hierarchy to identify the relative dominance of each of the groups 116 the user is a member of. When there is a conflict of assignment (for instance an application 112 is mandatory for one group and denied for another), the assignment for the most dominant group 116 becomes the one that is used. Only when there are application assignment conflicts will the assignment for the more dominant group prevail. For applications for which there are no conflicts, there is no need to apply the dominance rule and the application assignment prevails, regardless of the relative dominance of the group 116 to which the application 112 is assigned.

An application 112 registered in the system 100 can, optionally, have a set of attributes associated with it that determines the devices to which the application can be deployed, the attributed include but are not limited to:
Device model;
Device memory;
Operating System;
Firmware version;
Mobile Infrastructure type.

In addition to fixed device attributes such as the ones listed above, there may be a list of transient attributes that can be used to target devices. Transient attributes are those that change with time and may only temporarily prevent deployment of an application. Transient attributes associated with devices 130 include but are not limited to:
Device is not roaming;
Device must be switched on;
Device must be connected to the ‘Home’ wireless carrier.

If the system 100 determines, through group membership that a certain application 112 should be deployed to a device 130 then the application 112 will only be deployed if the device 130 matches the device targeting criteria associated with the application 112. If a transient pre-requisite prevents deployment of an application 112 the application 112 may be deployed once the transient pre-requisite is met.

Customer audit functions and application vendors wish to compare the number of software licenses paid for and the number being used on mobile devices. The system 100 contains methods for reporting on license usage and, optionally preventing license numbers being exceeded. The system 100 may provide a basic license report run by the internal system administrator and showing what devices 130/users 114 have a given application running on their device.

The system 100 may also have an automated system that provides an application server 122 with numbers of licenses deployed when a provisioning request 118 is made by the application server provisioning module 113. This then enables the application server 122 to determine, using its own licensing logic whether to provision the requested user. Each time the application server provisioning module 113 makes a provisioning request 118, the request contains, optionally, the total number of devices 130 that currently have the software deployed to them, the application server 122 then decides whether to provision the user or device and, optionally, sends a response back to the system 100 indicating whether the provisioning request 118 was successful and, optionally, the reason for any failure/success.

In some embodiments, the system 100 includes functionality to allow a third party to make a request to it from inside or outside the organization's firewall asking for information on the deployment of software. The request can be made by a software system or by an individual through a web page hosted by the system 100 or by another server on behalf of it. This requesting system contains security to ensure that only authorized individuals and systems can make requests of this type. The request can be for information on any software deployed by the organization to mobile devices and different levels of security and authentication allow the Mobile Device Life Cycle Management System administrator to fine tune which third parties can make requests and for what applications 112. This functionality can also allow limited write access to the Mobile Device Life Cycle Management System 100 by the third party; this facility could be used to allow the third party to raise the number of licenses held by the organization for instance.

The system 100 may also contain information relating to the maximum number of licenses for any software package or any version of any software package. This information is then used by the Mobile Device Life Cycle Management System 100 when it deploys applications 112 to mobile devices 130 in order to prevent unlicensed use. This facility is configurable on a per application 112, version and vendor level and can be disabled or enabled at a system-wide level. The system administrator can specify the action (or combination of actions) that is/are to occur when the maximum number of licenses is reached and/or is approaching that number and has passed a specified threshold, these actions include but are not limited to:
Preventing any more deployments of the application;
Sending a notification email to one or more email addresses;
Raising a system alert (e.g., Simple Network Management Protocol (“SNMP”));
Sending a message to one or more individuals or systems using a messaging system such as SMS or an Instant Messaging;
Communicate with an internal or external Application Programming Interface (“API”) (such as a web service) to initiate an action in an internal or external system (such as requesting a purchase order for more licenses).

The system 100 may also contain an optional interface that can be configured to read the license database (or other storage area) on a third party application server (e.g., 122) to determine the maximum number of licenses. This can be disabled/enabled on a per-application, version and vendor basis and enabled/disabled system-wide. This facility is architected to allow rapid customization for different vendors.

A mobile device infrastructure is a specific combination of software, hardware and other network components (Firewalls, servers, Carrier infrastructure, Internet etc), such as the proprietary or device-specific mobile device management servers 120. Sometimes a mobile infrastructure and/or server 120 will have the ability to store, manage and deploy IT policies 110 for mobile devices 130 native to its infrastructure.

As shown in FIG. 2, the system contains one or more interface modules 115 for the various mobile device infrastructures available. These modules 115 share a common architecture that enables interfaces for new mobile device infrastructures to be quickly developed. In the context of IT policy management the function of the Interface modules are:
To allow the system 100 to read IT policies 110 resident in the mobile device infrastructure or servers 120;
To present IT policies 110 to the system 100 in a consistent format, independent of the mobile device infrastructure or server 120;
To allow the system 100 to write back to the mobile device infrastructure or server 120 new or amended IT policies 110.

The system 100 can utilize one or more mobile device infrastructure interface modules 115 in order to manage IT policies 110 across those infrastructures.

As shown in FIG. 2, the system 100 is able to store IT policies 110 in its own databases, e.g., IT policy database 141. This means that it can store one or more IT policies 110, native to one or more mobile device infrastructures regardless of the mobile device infrastructure or format or data structure of the IT policy 110 when stored in its native mobile device infrastructure.

The mobile device infrastructure interface modules 115 are able to convert the mobile infrastructure-specific IT policies 110 into a standard format so that they can be stored by the Mobile Device Life Cycle Management System 100. This means that IT policies 110 from many mobile device infrastructures can be acted upon by the same set of Mobile Device Life Cycle Management System 100 software methods in a predictable and consistent way.

Once IT policies 110, regardless of originating mobile device infrastructure, are stored in the Mobile Device Life Cycle Management System 100 they are completely identical in structure and format other than the fact that they vary significantly in the settings and values that each contain. The system 100 enables a system administrator to edit one or more setting of an IT policy 110 and save those changes to the databases 140 of the system 100 and, optionally, save the change back to the originating mobile device infrastructure.

Some IT policy settings 110 will consist of name/value pairs indicative of the function or operation of the mobile device 130 governed by the IT policy, such as ‘Enable Camera=true’ or ‘Password Timeout=10’. In these cases, the Mobile Device Life Cycle Management System 100, though the mobile device infrastructure interface modules 115 or through a manual or automatic import process, is able to learn the available set of values for each name/value pair.

The system 100 contains functionality to enable new IT policies 110, for any connected mobile device infrastructure to be created. When a new IT policy 110 is to be created, the administrator may first identify an IT policy upon which it is to be based (e.g. the parent). The administrator then specifies the IT policy 110 setting changes that differentiate the parent from the child (the new policy may only differ from the parent in one or two settings). Once the changes have been made, the system 100 only stores the changed settings, not a complete new IT policy 110, and a name is given to the new child policy. This child policy can, in turn be used as a parent for another policy, and so on. There is no limit to the number of generations that can be created.

The reason that only changes to settings are stored at each IT policy generation (and not a whole new IT policy) is to implement IT policy inheritance. Typically a child IT policy 110 is created to service the specific need of a certain community (e.g., the need to access a certain secure application server 122) and this will require changing only one or two settings. For most of the time, the settings of the parent IT policy 110 accurately reflect the requirements of the user/device. Inheritance means that any setting changes made to a policy will be inherited by devices who have been assigned a policy from a subsequent generation unless those settings have been specifically overridden in one of those generations.

Although IT policies 110 in the Mobile Device Life Cycle Management System 100 may be stored as incremental changes to a parent policy, the system provides the option to view the IT policy 110 as a whole in other words to view and report on the complete set of settings for an IT policy 110 that are a combination of generational changes and inherited settings. Additionally, when the Mobile Device Life Cycle Management System 100 needs to write back an IT policy 110 to a mobile device infrastructure, the IT policy 110 that is written is complete and also contains all generational and inherited changes.

In order to offer maximum flexibility the system 100 may also contain an option to allow the system administrator to turn-off IT policy inheritance at a system-wide level or at any IT policy generation. This means that when a new IT policy 110 is created, a complete copy of the parent is made and stored and no setting changes made to the parent from that point on are inherited.

When installed in an organization, the system 100 may contain IT policies 110 from more than one mobile device infrastructure. Because users in the same role may have different devices from different mobile device infrastructure, the system 100 uses IT policy Abstraction in order to assign IT policies 110 to users 114.

Because IT policies from different mobile device infrastructures contain different settings and users 114 with the same role may have different devices 130, it may not be possible to have a single IT policy 110 that suits all users with a common role. The Mobile Device Life Cycle Management System 100 has a system to allow the system administrator to group IT policies 110 from different mobile device 130 so that no matter what device a user has, the IT policy 110 in force is always appropriate to the role. This is achieved through IT policy 110 abstraction.

As shown in FIG. 2, IT policies 110 are abstracted by using an entity referred to herein as a security profile 111. A security profile 111 represents a set of IT policies 110, from different mobile infrastructures that are appropriate for one or more user roles.

The system administrator will create one or more security profiles 111 and give them a suitable name (e.g. ‘Field Worker’, ‘Senior Exec’ etc) and then choose one IT policy 110 from each connected mobile device infrastructure, associating that with the security profile. This will mean, for instance, that the Security Profile ‘Field Worker’ will have the most appropriate IT policy 110 for each device type and mobile device infrastructure associated with it, ensuring that whatever device a ‘Field Worker’ has, it will always meet corporate IT policy 110 standards for that role.

Once a security profile has been created and IT policies associated with it, it can then be assigned to a community of users. This is done by associating the Security Profile with one or more groups 116. Once a security profile 111 is associated with a group 116, all members of that group, regardless of mobile device 130 type or mobile device infrastructure will have the correct IT policy 110 in force on their device.

If a security profile 111 does not have an associated IT policy 110 for all connected mobile device infrastructures (one or more may not have been associated by the system administrator) then the Mobile Device Life Cycle Management System 100 will automatically assign a default IT policy 110, nominated for this purpose by the system administrator. The System 100 will also enable the system administrator to choose not to use security profiles and instead associated IT policies 110 directly with groups 116.

A user will frequently exist in more than one group 116 and therefore could be subject to more than one IT policy 110/security profile 111. In these cases, the system 100 has to determine which IT policy 110/security profile 111 to assign to the user. The system 100 may employ several methods for determining which IT policy 110/security profile 111 to apply when a user is a member of more than one group 116. These methods may include group dominance, administrator intervention, security profile/IT policy dominance, and least/most restrictive.

In a group dominance method, a system administrator may define a dominance hierarchy of all groups 116 (e.g., which could be the same as, or separate from, the application group hierarchy). When a user is a member of more than one group 116, the group dominance hierarchy is consulted by the system 100 and the Security Policy associated with the most dominant group that the user is a member of is put in force for individuals that are members of that particular combination of groups.

The admin intervention method requires the Mobile Device Life Cycle Management System 100 to alert the system administrator to all occurrences of multiple group 116 membership when this affects Security Profile assignment. The system administrator then specifies for each individual concerned, or for each unique group 116 intersection, which Security Profile should dominate. Until the system administrator has specified which Security Profile dominates, the system 100 will place in force a temporary Security Profile created and nominated by the system administrator for this purpose.

The security profile/IT policy dominance method requires the system administrator to place all Security Profiles (or IT policies if security profiles are not being used) into a dominance hierarchy. When the system 100 needs to determine, in the case of multiple group 116 membership, which Security Profile/IT policy to assign, the dominance hierarchy is consulted and the most dominance prevails.

In some cases, the system administrator will want the most (and/or the least) restrictive Security Profile/IT policy to be in force when a user is a member of more than one group 116. This method requires that the system 100 is able to automatically determine which of two settings are the most/least restrictive and how to determine at an IT policy-level how the combination of least/most restrictive settings accumulate to determine which of two or more IT policies are the most/least restrictive.

For some mobile device infrastructures, it will be possible to specify that a value of ‘false’ to some or all settings implies ‘most restrictive’ for other it will be ‘true’. In some cases where true/false is replaced with some other value such as a number or text then a setting-specific rule can be set.

As an alternative to assigning entire IT policies 110 to a user, group 116 or application 112, a system administrator may choose to take the more granular approach of assigning individual IT policy rules by employing an IT policy rule assignment. An IT policy contains several IT policy rules, in some cases many hundreds of rules. The system allows the association of a single IT policy rule to a user 114, group 116 or application 112. In most cases when this happens the user 114 will usually (but not always) also be the recipient of a complete IT policy 110 through additional group 116 membership or by having a default IT policy 110 previously assigned to them by the system, in which case the assignment of an individual IT policy rule represents an incremental change or addition to the existing IT policy 110.

IT policy rule inheritance: a mobile user 114 may end up with a situation where they have a single IT policy 110 assigned to them by virtue of their membership of a group 116 and additionally a number of individual IT policy rules also assigned to them, either directly or through other group memberships or application targeting. The ‘net effect’ of this is a new IT policy 110 containing all the rules of the initial IT policy 110 plus the accumulated changes and new IT policy rules. If a user has been subject to IT policy rule changes then the system will create a new IT policy 110, stored using the internal representation of an IT policy 110. This new IT policy 110 is then communicated to the relevant proprietary or device-specific mobile management server 120 for execution and deployment to the device 130.

Occasionally the system will identify a situation where there is an IT policy rule conflict. For instance the user may be assigned an application 112 for which the IT policy rule ‘Allow Bluetooth’ is set to ‘True’ and also be a member of a group 116 where the same rule is set to ‘False’. To handle conflicts such as this the system administrator can specify the relative dominance of the three levels of IT policy rule assignment (User 114, group 116 and application 112) so that the system can determine how the conflicting assignment is to be resolved. Additionally, the system administrator can specify the relative dominance of each group 116 and application 112 to deal with situations when the IT policy 110 conflict occurs purely or jointly at a group 116 or application 112 level.

As shown in FIG. 2, some embodiments of the present invention comprise an event based administration module 117 or method. Event based Administration (EBA) is a method for automating admin activities upon mobile devices 130. An event in this context is any action whose occurrence would require a change of some kind to occur on a mobile device 130. An example of such an event is a person being promoted to a new job with the organization, warranting different applications 112 and/or IT policies 110 on their device 130. Another example would be a person leaving the organization, meaning that their device 130 would have to be disconnected from the organization's network and have all company data removed.

EBA consists of associating one or more admin actions with one or more events, detecting those events and causing those admin events to be executed through instructions to a proprietary or device-specific mobile management server 120.

An event object 119 is the internal generic representation of an EBA event. An event objection 119 has sets of attributes such as the admin events to execute (via one or more proprietary or device-specific mobile management servers 120), the identifier of the inbound and/or out bound event API instance and the identifier of the group(s) 116 where membership changes deem an event to have occurred.

The EBA module 117 may determine changes in group membership. A group 116 represents a community of individuals 114 and/or groups 116 as defined elsewhere in this document. The EBA module 117 determines that an event has occurred if:
1. An individual joins a group;
2. An individual leaves a group;
3. An individual leaves one group and joins another.

The EBA module 117 has two methods for determining when an event has occurred: 1) By regularly polling group membership; and 2) Alert based.

Some groups 116 may be maintained by systems unrelated to the Mobile Device Life Cycle Management System 100 and contain functionality that enables an alert to be generated when group 116 membership has changed. This alert may be used by the EBA module as a method for determining that an event has occurred. Other groups will require inspection or polling by the EBA module to determine changes in membership.

In some embodiments, more than one group 116 can be used in order to generate an event. In this case a change of membership in any one of the groups 116 will trigger the associated admin event. For groups 116 that require regular polling, the administrator can specify the polling frequency at a system-wide and/or group-specific level. Groups 116 that are used for Event Based Administration may also be used elsewhere within the Mobile Device Life Cycle Management System 100 for other purposes.

For inbound events, the system may include a generic API available to any external system that the system administrator wishes. This API is designed to allow external systems to trigger an EBA event, causing the EBA system to execute the associated admin actions by sending instructions to one or more Mobile device management systems. For outbound events, any EBA admin event can notify the outbound event API so that external systems can become aware of the event. The API can provide direct alerts to external systems or respond to a query from an external system, providing information on the event status.

There is no pre-determined set of admin events 119 that can be performed by the EBA module 117. The architecture of the module 117 is such that is able to instruct another internal or external system to perform the required event. It does this by providing the instructions in a form that is understandable by the other system (such as a web service or other API) and by providing a set of information associated with the user. Additionally the EBA module 117 may instruct other modules within the Mobile Device Life Cycle Management System to perform an admin event.

When the EBA module 117 is included in a Mobile Device Life Cycle Management System 100 as shown in FIG. 2, there may be a set admin functionality internal to the Mobile Device Life Cycle Management System 100 (such as remote wipe of a device) that administrators may wish to make subject to Event Based Administration. To facilitate this, this admin functionality may be made available as selectable options within the EBA module that can quickly be associated with the group(s) where a change of membership defines an event.

The set of information passed to the internal or external system is flexible and includes, but is not limited to:
1. User name;
2. User Email address;
3. Device PIN, IMEI, Phone number;
4. Device type;
5. Directory Services Identifier.

The EBA module 117 may include additional admin functionality to allow the administrator to determine what information is automatically passed to the other system.

Although the invention has been described with reference to a particular arrangement of parts, features and the like, these are not intended to exhaust all possible arrangements or features, and indeed many modifications and variations will be ascertainable to those of skill in the art.

What is claimed is:

1. A system for the management of mobile devices, comprising:
a system server having at least one database, wherein the database includes data objects indicative of a plurality of groups of mobile device users, a plurality of applications, and a plurality of IT policies, wherein said data objects are independent of a mobile device type;
an interface module on said system server for generating instructions to communicate to each of two or more device-specific mobile device management servers, wherein each of the device-specific mobile device management servers are in communication with a plurality of mobile devices; and
software executing on said system server for deploying at least one of an application and an IT policy to one or more of the plurality of mobile devices by transmitting the instructions to at least one of said plurality of device-specific mobile device management servers.

2. The system according to claim 1, wherein the system further comprises the two or more device-specific mobile device management servers in communication with said system server and the plurality of mobile devices accessible by said device-specific mobile device management servers.

3. The system according to claim 1, further comprising:
an event module on said system server detecting changes in the data objects indicative of the groups.

4. The system according to claim 3, wherein said event module detects a user leaving a group and updates one of an application and IT policy on a mobile device associated with the user.

5. The system according to claim 1, wherein said event module detects a user joining a group and updates one of an application and IT policy on a mobile device associated with the user.

6. The system according to claim 1, wherein the at least one database includes a group database accessible by said system server comprising data associated with each group data object.

7. The system according to claim 1, further comprising:
an application database accessible by said system server comprising a plurality of applications identified by the data objects indicative of a plurality of the applications.

8. The system according to claim 7, further comprising:
an application server in communication with said application database;
a provisioning module on said system server for communicating a provisioning request, indicative of one or more mobile device users, to said application server to provision the users to access the application server.

9. The system according to claim 8, wherein said provisioning module communicates the provisioning request upon one of an application being deployed to a mobile device.

10. The system according to claim 1, wherein associations between two or more the data objects are defined in the database.

11. The system according to claim 10, wherein the associations include associations between an application and one or more IT policies.

12. The system according to claim 11, wherein each application is associated with at least one IT policy.

13. The system according to claim 1, wherein at least one application is associated with one or more groups.

14. The system according to claim 13, wherein each application associated with a group is defined as one of mandatory, optional or denied for the group.

15. The system according to claim 13, wherein a method of deploying each application is dependent on whether the application is mandatory, optional or denied.

16. The system according to claim 1, further comprising:
an IT policy database accessible by said system comprising data associated with each IT policy data object.

17. The system according to claim 1, wherein each of said data objects are stored in a common data format.

18. The system according to claim 1, wherein each IT policy data object comprises data indicative of one or more rules.

19. The system according to claim 1, wherein a first one of the IT policy data objects is dependent on a second one of the IT policy objects, wherein only differences between the second one of IT policies and the first one of the IT policies are stored in the database.

20. The system according to claim 1, wherein the data objects include user data comprising at least one of a name, user name and job title for each of a plurality of mobile device users.

21. The system according to claim 1, wherein an application is deployed via one of an email link, an over-the-air method, and a website download.

22. The system according to claim 1, wherein said software for deploying at least one of an application and an IT policy determines if a license is available for an application to be deployed and deploys the application if a license is available.

23. A method for managing mobile devices, comprising the steps of:
receiving data objects indicative of a plurality of groups of mobile device users, a plurality of applications, and a plurality of IT policies, wherein said data objects are independent of a mobile device type;
determining at least one of an application and an IT policy associated with a group of mobile device users;
generating instructions to communicate to each of two or more device-specific mobile device management servers, wherein each of the device-specific mobile device management servers are in communication with a plurality of mobile devices; and
deploying at least one of the application and the IT policy to one or more of the plurality of mobile devices by transmitting the instructions to at least one of said plurality of device-specific mobile device management servers.

24. The method according to claim 23, further comprising the step of:
associating each application object with at least one group object and at least one IT policy object.

25. The method according to claim 23, wherein the application is deployed via one of an email link, an over-the-air method, and a website download.

26. The method according to claim 25, wherein the method of deployment is dependent on whether the application is mandatory, optional or denied for the group.

27. The method according to claim 23, wherein two or more conflicting IT policies are determined, and wherein the least restrictive IT policy is deployed.

28. The method according to claim 23, wherein two or more conflicting IT policies are determined, and wherein the most restrictive IT policy is deployed.
